(19) United States
(12) Patent Application Publication
(10) Pub. No.: US 2014/0017716 A1
(43) Pub. Date: Jan. 16, 2014

(54) PROTEOLYTIC DIGESTION KIT WITH DRIED REAGENTS

(71) Applicant: SISCAPA Assay Technologies, Inc., Washington, DC (US)

(72) Inventor: N. Leigh ANDERSON, Washington, DC (US)

(21) Appl. No.: 13/940,248

(22) Filed: Jul. 11, 2013

Related U.S. Application Data
(60) Provisional application No. 61/670,493, filed on Jul. 11, 2012.

(51) Int. Cl. G01N 27/62

(52) U.S. Cl. CPC G01N 27/62
USPC 435/23; 436/86; 435/213

(57) ABSTRACT

Compositions and methods are provided for the rapid and efficient denaturation and degradation of protein samples. The compositions and methods produce samples that can readily be analyzed by, for example, mass spectrometry. Unwanted dilution of the sample is avoided and the samples and methods are amenable for use with robotic laboratory sample handling instruments. The compositions and methods surprisingly provide significantly improved reproducibility and accuracy of the resulting mass spectrometric analyses.

This application claims priority to provisional application No. 61/670,493, filed Jul. 11, 2012, the contents of which are hereby incorporated by reference in their entirety.

### SUMMARY

A variety of protein analytical methods, including the SISCAPA method, incorporate a proteolytic digestion step wherein an enzyme or chemical reagent is used to cleave proteins to peptides at specific sequence sites. Methods used to achieve digestion typically perform better when the proteins to be digested have been denatured—i.e., their 3-D structures “opened up” or unfolded so as to allow access to internal cleavage sites—and their internal disulfide bonds (between cysteine residues) disrupted (by disulfide reduction) and their reformation prevented by alkylation of the cysteines. In order to enable digestion by an enzyme such as trypsin, it may be necessary to remove or dilute chemical agents added earlier to denature the sample proteins (to prevent their denaturing the trypsin enzyme and thus inhibiting its desired activity in cleaving the sample proteins). Thus a digestion method may, and likely will, consist of a series of treatment steps during which the sample proteins are progressively unfolded and cut up into peptides. The reproducibility and/or completeness of this digestion process is critical to the utility of the results of the subsequent analytical methods.

In designing a reproducible digestion method for use on large numbers of samples, several features are highly desirable:
1. Addition-only methodology.
2. Absence of separative steps.
3. Accurate addition of pre-measured reagents.
4. Avoidance of precipitation of sample proteins and/or resulting peptides.

Methods are provided to make the digestion process as reproducible as possible by providing the necessary reagents in pre-measured, solid form, while incorporating the desirable features listed above.

### BRIEF DESCRIPTION OF THE DRAWINGS

FIG. 1. Diagram of the contents and location of reagents in a kit for tryptic digestion packaged in two microplates.

FIG. 2. Diagram of the contents and location of reagents in a kit for tryptic digestion. And subsequent SISCAPA assay packaged in two microplates.

FIG. 3. Diagram of the contents and location of reagents in a kit for a SISCAPA assay packaged in one microplate.

FIG. 4. Schematic diagram of the addition-only sample digestion method followed by the SISCAPA peptide measurement method

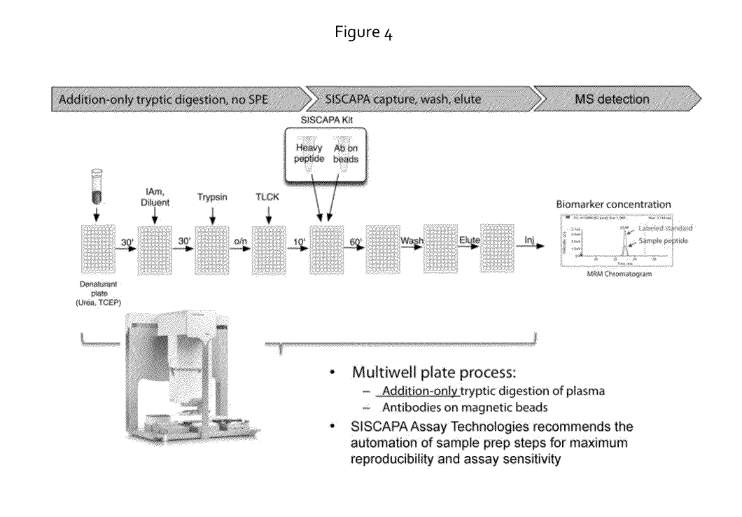

FIG. 5. Response curves showing the results (fmol of PCI peptide measured) when varying amounts of i) labeled internal standard (SIS) peptide are added to a sample digest (PCI Rev), showing the linearity of the assay and ii) unlabeled analyte peptide are added to a digest sample (PCI Fwd), showing the endogenous level of analyte in the sample digest itself.

FIG. 6. Measured amount of PCI peptide in 10, 25, 50 and 100 ul aliquots of pooled plasma digested with the methods described herein.

FIG. 7. Measured amount of PCI peptide in human and goat plasma (which lacks the PCI peptide sequence) and a 1:1 moisture between human and goat, establishing linearity of the process.

### DETAILED DESCRIPTION

The term “amount”, “concentration” or “level” of an analyte or internal standard means the physical quantity of the substance referred to, either in terms of mass (or equivalently moles) or in terms of concentration (the amount of mass or moles per volume of a solution or liquid sample).

The term “analyte” or “ligand” may be any of a variety of different molecules, or components, pieces, fragments or sections of different molecules that are to be measured or quantitated in a sample. An analyte may thus be a protein, a peptide derived from a protein by digestion or other fragmentation technique, a small molecule (such as a hormone, metabolite, drug, drug metabolite), a nucleic acid (DNA, RNA, and fragments thereof produced by enzymatic, chemical or other fragmentation processes), a glycan structure, an atomic or diatomic ion, or any other atom or molecule of material substance that is measured by an analytical method.

The term “antibody” means a monoclonal or monospecific polyclonal immunoglobulin protein such as IgG or IgM. An antibody may be a whole antibody or antigen-binding antibody fragment derived from a species (e.g., rabbit or mouse) commonly employed to produce antibodies against a selected antigen, or may be derived from recombinant methods such as protein expression, and phage/virus display. See, e.g., U.S. Pat. Nos. 7,732,168; 7,575,896; and 7,431,927, which describe preparation of rabbit monoclonal antibodies. Antibody fragments may be any antigen-binding fragment that can be prepared by conventional protein chemistry methods or may be engineered fragments such as scFv, diabodies, minibodies and the like.

The term “bind” or “react” means any physical attachment or close association, which may be permanent or temporary. Generally, reversible binding includes aspects of charge interactions, hydrogen bonding, hydrophobic forces, van der Waals forces etc., that facilitate physical attachment between the molecule of interest and the analyte being measuring. The “binding” interaction may be brief as in the situation where binding causes a chemical reaction to occur. Reactions resulting from contact between the binding agent and the analyte are also within the definition of binding for the purposes of the present technology, provided they can be later reversed to release a monitor fragment.

The term “binding agent” means a molecule or substance having an affinity for one or more analytes, and includes antibodies (for example polyclonal, monoclonal, single chain, and modifications thereof), aptamers (made of DNA, RNA, modified nucleotides, peptides, and other compounds), etc. “Specific binding agents” are those with particular affinity for a specific analyte molecule. It will be understood that other classes of molecules such as DNA and RNA aptamers configured as specific and high affinity binding agents may, be used as alternatives to antibodies or antibody fragments in appropriate circumstances.

The term “carrier” means a carrier molecule, a carrier particle or a carrier surface.

The term “denaturant” includes a range of chaotropic and other chemical agents that act to disrupt or loosen the 3-D structure of proteins without breaking covalent bonds, thereby rendering them more susceptible to proteolytic treatment. Examples include urea, guanidine hydrochloride, ammonium thiocyanate, trifluoroethanol and deoxycholate, as well as detergents such as sodium dodecyl sulfate, “Rapigest”, as well as solvents such as acetonitrile, methanol and the like. The concept of denaturant includes non-material influences capable of causing perturbation to protein structures, such as heat, microwave irradiation, ultrasound, and pressure fluctuations.

The term dissolvable tablet refers to a discrete dry object containing a measured amount of one or more reagents formulated so as to dissolve in an applied liquid—i.e. a “denaturant tablet”. The tablet may be formed by lyophilization of a liquid (e.g., LyoSphere technology), coating, stamping, compression of a powder, or a variety of other means, and may contain binders, excipients, coatings and other substances contributing improved physical properties or control of properties such as speed of dissolution.

The term “electrospray ionization” (ESI) refers to a method for the transfer of analyte molecules in solution into the gas and ultimately vacuum phase through use of a combination of liquid delivery to a pointed exit and high local electric field.

The term “immobilized enzyme” means any form of enzyme that is fixed to the matrix of a support by covalent or non-covalent interaction such that the majority of the enzyme remains attached to the support of the membrane.

The term “magnet”, “permanent magnet”, or “electromagnet” are used here to mean any physical system, whether electrically powered or static, capable of generating a magnetic field.

The term “magnetic field” or “magnetic field gradient” are used here interchangeably, and refer to a physical region within which a spatially varying magnetic field exists.

The terms “magnetic particle” and “magnetic bead” are used interchangeably and mean particulate substances capable of carrying binding agents (whether attached covalently or non-covalently, permanently or temporarily) or serving other functions, and which can respond to the presence of a magnetic field gradient by movement. The term includes beads that are referred to as paramagnetic, superparamagnetic, and diamagnetic.

The terms “particle” or “bead” mean any kind of particle in the size range between 10 nm and 1 cm, and includes magnetic particles and beads.

The term “MALDI” means Matrix Assisted Laser Desorption Ionization and related techniques such as SELDI, and includes any technique that generates charged analyte ions from a solid analyte-containing material on a solid support under the influence of a laser or other means of imparting a short energy pulse.

The term “Mass spectrometer” (or “MS”) means an instrument capable of separating molecules on the basis of their mass m, or m/z where z is molecular charge, and then detecting them. In one embodiment, mass spectrometers detect molecules quantitatively. An MS may use one, two, or more stages of mass selection. In the case of multistage selection, some means of fragmenting the molecules is typically used between stages, so that later stages resolve fragments of molecules selected in earlier stages. Use of multiple stages typically affords improved overall specificity compared to a single stage device. Often, quantitation of molecules is performed in a triple-quadrupole mass spectrometer, but it will be understood herein that a variety of different MS configurations may be used to analyze the molecules described, and specifically MALDI instruments including MALDI-TOF, MALDI-TOF/TOF, and MALDI-TQMS and electrospray instruments including ESI-TQMS and ESI-QTOF, in which TOF means time of flight, TQMS means triple quadrupole MS, and QTOF means quadrupole TOF.

The term “monitor fragment” may mean any piece of an analyte up to and including the whole analyte that can be produced by a reproducible fragmentation process (or without a fragmentation if the monitor fragment is the whole analyte) and whose abundance or concentration can be used as a surrogate for the abundance or concentration of the analyte.

The term “monitor peptide” or “target peptide” means a peptide chosen as a monitor fragment of a protein or peptide.

The term “Natural” or “Nat” means the form of such a peptide that is derived from a natural biological sample by proteolytic digestion, and thus, contains approximately natural abundances of elemental isotopes. Nat peptides typically do not contain appreciable amounts of a stable isotope label such as is intentionally incorporated in SIS internal standards.

The term “personal reference level” and “personal reference range” refer to the use of analyte levels established previously for an individual patient in the interpretation of test results.

The term “proteolytic enzyme cleavage site” refers to a site within an extended SIS peptide sequence at which the chosen proteolytic treatment (typically an enzyme such as trypsin) cleaves the extended SIS sequence, releasing peptides fragments (typically two) of which one is the SIS peptide sequence (identical to the analyte, or Nat, sequence for which the SIS serves as an internal standard).

The term “proteolytic treatment” or “enzyme” may refer any of a large number of different enzymes, including trypsin, chymotrypsin, lys-C, v8 and the like, as well as chemicals, such as cyanogen bromide. In this context, a proteolytic treatment acts to cleave peptide bonds in a protein or peptide in a sequence-specific manner, generating a collection of shorter peptides (a digest).

The term “proteotypic peptide” means a peptide whose sequence is unique to a specific protein in an organism, and therefore may be used as a stoichiometric surrogate for the protein, or at least for one or more forms of the protein in the case of a protein with splice variants.

The term “sample” means any complex biologically-generated sample derived from humans, other animals, plants or microorganisms, or any combinations of these sources. “Complex digest” means a proteolytic digest of any of these samples resulting from use of a proteolytic treatment.

The terms “SIS”, “stable isotope standard” and “stable isotope labeled version of a peptide or protein analyte” mean a peptide or protein, such as a peptide or protein having a unique sequence that is identical or substantially identical to that of a selected peptide or protein analyte, and including a label of some kind (e.g., a stable isotope) that allows its use as an internal standard for mass spectrometric quantitation of the natural (unlabeled, typically biologically generated) version of the analyte (see U.S. Pat. No. 7,632,686 “High Sensitivity Quantitation of Peptides by Mass Spectrometry”). In one embodiment, a SIS peptide or protein comprises a peptide sequence that has a structure that is chemically identical to that of the molecule for which it will serve as a standard, except that it has isotopic labels at one or more positions that alter its mass. Hence a SIS is 1) recognized as equivalent to the analyte in a pre-analytical workflow, and is not appreciably differentially enriched or depleted compared to the analyte prior to mass spectrometric analysis, and 2) differs from it in a manner that can be distinguished by a mass spectrometer, either through direct measurement of molecular mass or through mass measurement of fragments (e.g., through MS/MS analysis), or by another equivalent means. Stable isotope standards include peptides having non-material modifications of this sequence, such as a single amino acid substitution (as may occur in natural genetic polymorphisms), substitutions (including covalent conjugations of cysteine or other specific residues), or chemical modifications (including glycosylation, phosphorylation, and other well-known post-translational modifications) that do not materially affect enrichment or depletion compared to the analyte prior to mass spectrometric analysis. In one embodiment, SIS peptides are generated by chemical synthesis or by in vitro or in vivo biosynthesis so as to produce a high level of substitution (>95%, >96%, >97%, >98% or >99%) of each stable isotope (e.g., ¹³C, ¹⁵N, ¹⁸O or ²H) at the specific sites within the peptide structure where the isotope(s) is/are incorporated (i.e., those sites that depart significantly from the natural un-enriched isotope distribution).

The term “SISCAPA” means the method described in U.S. Pat. No. 7,632,686, entitled High Sensitivity Quantitation of Peptides by Mass Spectrometry and in Mass Spectrometric Quantitation of Peptides and Proteins Using Stable Isotope Standards and Capture by Anti-Peptide Antibodies (SISCAPA). Anderson, N. L., Anderson, N. G., Haines, L. R., Hardie, D. B., Olafson. R. W., and Pearson, T. W, Journal of Proteome Research 3: 235-44 (2004).

The term “small molecule” or “metabolite” means a multi-atom molecule other than proteins, peptides produced by digestion of proteins, and DNA; the term can include but is not limited to amino acids, steroid and other small hormones, metabolic intermediate compounds, drugs, drug metabolites, toxicants and their metabolites, and fragments of larger biomolecules.

The term “stable isotope” means an isotope of an element naturally occurring or capable of substitution in proteins or peptides that is stable (does not decay by radioactive mechanisms) over a period of a day or more. The primary examples of interest in this context are C, N, H, and O, of which the most commonly used are ¹³C and ¹⁵N.

The term “standardized sample” means a protein or peptide sample to which stable isotope labeled version(s) of one or more peptide or protein analytes have been added at levels corresponding to test evaluation thresholds to serve as internal standards.

The term “undigested analyte” or “UA” means a molecule that is present in a sample but that is not the product of a proteolytic digestion of a sample protein. UA's include, but are not limited to, small molecules, metabolites, drugs and their metabolites, compounds absorbed or ingested from the environment, and nucleic acids (including microRNA's and fragments of DNA, rRNA and mRNA).

The following embodiments of the present technology make use of a series of concepts described in this specification. These concepts provide background as to specific embodiments of the methods and compositions described herein.

The SISCAPA Method

Recently it has become possible to measure proteins accurately in multiplex panels using mass spectrometry—a direct detection approach in contrast to the indirect detection in immunoassays based on antibodies. The power of this mass spectrometric approach is further increased by means of sample preparation steps to improve its sensitivity and throughput. A prominent means of such improvement is the SISCAPA technology. SISCAPA assays combine affinity enrichment of specific peptides with quantitative measurement of those peptides by mass spectrometry. In order to detect and quantitatively measure protein analytes, the SISCAPA technology makes use of anti-peptide antibodies (or any other binding entity that can reversibly bind a specific peptide sequence of about 4-20 residues) to capture specific peptides from a highly complex mixture of peptides, such as that arising, for example, from the specific cleavage of a protein mixture (like human serum or a tissue lysate) by a proteolytic enzyme such as trypsin or a chemical reagent such as cyanogen bromide. By capturing a specific peptide through binding to an antibody (the antibody being typically coupled to a solid support either before or after peptide binding), followed by washing of the antibody:peptide complex to remove unbound peptides, and finally elution of the bound peptide into a small volume, the SISCAPA technology makes it possible to enrich specific peptides that may be present at low concentrations in the whole digest, and that are therefore undetectable in simple mass spectrometry (MS) or liquid chromatography-MS (LC/MS) systems against the background of more abundant peptides present in the mixture. SISCAPA also provides a sample that is much less complex, and therefore exhibits lesser ‘matrix effects’ and fewer analytical interferences, than the starting digest, which in turn enables use of shorter (or no) additional separation processes to introduce samples into a suitable mass spectrometer.

The enrichment step in SISCAPA is intended to capture peptides of high, medium or low abundance and present them for MS analysis; it therefore discards information as to the relative abundance of a peptide in the starting mixture in order to boost detection sensitivity. This abundance information can be recovered, however, through the use of isotope dilution methods: the SISCAPA technology makes use of such methods (e.g., by using stable isotope labeled versions of target peptides) in combination with specific peptide enrichment, to provide a method for quantitative analysis of peptides, including low-abundance peptides.

The approach to standardization in SISCAPA is to create a version of the peptide to be measured which incorporates one or more stable isotopes of mass different from the predominant natural isotope, thus, forming a labeled peptide variant that is chemically identical (or nearly-identical) to the natural peptide present in the mixture, but which is nevertheless distinguishable by a mass spectrometer because of its altered peptide mass due to the isotopic label(s). The isotopic peptide variant (a Stable Isotope-labeled Standard, or SIS) is used as an internal standard, added to the sample peptide mixture at a known concentration before enrichment by antibody capture. The antibody thus captures and enriches both the natural and the labeled peptide together (having no differential affinity for either since they are chemically the same) according to their relative abundances in the sample. Since the labeled peptide is added at a known concentration, the ratio between the amounts of the natural and labeled forms detected by the final MS analysis allows the concentration of the natural peptide in the sample mixture to be calculated. Thus, the SISCAPA technology makes it possible to measure the quantity of a peptide of low abundance in a complex mixture and, since the peptide is typically produced by quantitative (complete) cleavage of sample proteins, the abundance of the parent protein in the mixture of proteins can be deduced. The SISCAPA technology can be multiplexed to cover multiple peptides measured in parallel, and can be automated through computer control to afford a general system for protein measurement.

An alternative to using SIS peptides is to use multiple copies of SIS peptides arranged as a linear polypeptide strand known as polySIS peptides. PolySIS peptides have been described, for example, in U.S. patent application Ser. No. 11/147,397 and may be prepared chemically, in vitro or in vivo using the same techniques used for SIS peptides. PolySIS peptides may also be prepared in “extended SIS” form and coupled to a carrier in the same fashion that SIS peptides or extended SIS peptides are attached.

The foregoing disclosure outlines a number of embodiments in terms of the SISCAPA method and associated quantitative mass spectrometry methods, and therefore represents one set of embodiments that may be employed in the application of the present technology. It will be appreciated that the methods and compositions disclosed herein are not limited to the SISCAPA method, but may be applied to other methods that employ internal peptide standards and the like.

### EMBODIMENTS

The compositions and methods described can be used for any size of sample but are particularly useful and amenable for use with samples having sizes that are typically used in clinical laboratory work. Thus, a typical sample size is on the order of 1-500 μl, advantageously 2-250 μl, 5-200 μl, 10-100 μl, and the like. A sample size of 5-20 μl is particularly suited to the methods described herein. Moreover, these sample sizes minimize the amount of clinical sample required and are amenable for use with laboratory robots, such as sample-handling robots.

Urea-Based Addition-Only, Urea/TCEP/TrisHCl Lyophilized in Plates.

In a first embodiment, the reagents required to implement a tryptic digestion method for processing blood plasma, whole blood (or other protein containing samples) are provided in pre-measured dried form. The method avoids the potential for losses of sample components by carrying out all the sequential steps of protein denaturation, cysteine reduction, cysteine alkylation, dilution of denaurant, addition of trypsin, and elimination of trypsin activity post-digestion using only additions of reagents to the sample; i.e., no separation, fractionation or transfer steps are employed prior to the optional use of SISCAPA enrichment of specific target peptides.

The following example calculations indicate the amounts of successive reagents needed to carry out the steps of a digestion protocol designed to process a 10 microliter sample of human plasma:

| | | |
|---|---|---|
| Plasma sample volume | 10.00 | uL |
| Protein conc in plasma | 73.13 | mg/ml |
| Protein (ug) | 731.27 | ug |
| SH conc in plasma | 2.68E−02M | |
| Moles SH in plasma proteins | 2.68E−07 | moles |
| TCEP excess over Cys | 2.00 | X |
| Moles TCEP | 5.36E−07 | moles |
| Mass of TCEP | 0.15 | mg |
| Molar TCEP | 0.054M | |
| Molar EDTA | 0.02M | |
| IAm excess over Cys | 1.50 | X |
| Moles IAm | 4.02E−07 | moles |
| Mass iodoacetamide | 0.07 | mg |
| Moles Cysteine | 4.02E−07 | moles |
| Mass Cysteine | 0.05 | mg |
| Urea | 9.00M | |
| Volume of 9M urea to be lyophilized | 16.90 | ul |
| Vol of water in 1 ml urea sol'n | 0.59 | ml |
| Mass of urea | 9.13 | mg |
| Diluted denat conc for trypsin | 1.00M | |
| Total water added to dilute urea | 135.16 | ul |
| Tris HCl buffer pH 8.5 in urea | 0.50M | |
| Mass of TrisHCl pH 8.5 | 1.11 | mg |
| Tris HCl buffer 8.5 diluent | 0.25M | |
| NaN3 final | 0.09% | |
| CHAPS final | 0.10% | |
| Substrate:Trypsin ratio | 20 | X |
| Trypsin per well | 36.56 | ug |
| Trypsin per well | 1.50E−09 | moles |
| Inhibitor excess over trypsin | 2.00 | X |
| TLCK (ug) | 1.11 | ug |

A 10 μl sample of human plasma contains, on average ˜731 μg of protein. Using the approximate cysteine content of plasma protein derived from the known sequences and concentrations of the major plasma proteins, the protein in the sample contains ˜2.7e-7 moles of cysteine (plasma contains about 27 mM cysteine in its proteins). Therefore an appropriate amount of tris-carboxyethylphosphine (TCEP) disulfide reducing agent (Pierce Chemical Co.) would be twice this, or 5.4e-7 moles TCEP. TCEP is naturally quite acidic, and thus the TCEP is neutralized to avoid changing the pH of the solution. After reduction, the now-free cysteine residues will be blocked by addition of a 2-fold excess (5.4e-7 moles) of iodoacetamide (IAm). Any excess IAm remaining after reaction with the cysteines can be removed by reaction with an equivalent amount of a thiol compound such as dithioerythritol or the like (DTE).

In order to denature the plasma proteins, one approach is to add a chaotropic agent such as urea at high concentration, e.g., the maximal solubility of urea in water, which is ˜9M. Since the plasma sample volume will dilute any added 9M urea solution to a lower urea concentration, either a lower final urea concentration must be accepted, or a very large volume of 9M urea must be added to a small plasma sample, or the plasma must be added to an appropriate amount of solid urea, dissolving it and establishing a high urea concentration in a minimal volume. Here the last of these approaches—adding sample to solid urea—is used so as to maximize the denaturant concentration while minimizing the dilution of sample. Minimal dilution during denaturation is important since it will be necessary to dilute out the urea before adding the enzyme trypsin to carry out the digestion (trypsin being inhibited in its activity by urea concentrations higher than approximately 1M. It is also convenient to have present a biological buffer such as Trishydroxymethylaminomethane-HCl (TrisHCl) in sufficient quantity (here 0.5M) and at such as pH (here 8.5) to stabilize the plasma sample at a pH suitable for the following chemical and enzymatic treatments.

The amount of trypsin needed depends on the amount of protein to be digested and the speed of digestion required. Typically an amount is used equal to 1/20 to 1/50 of the mass of the sample protein to be digested. In this example we use 1/20 of 731 μg=37 μg of trypsin per 10 μL plasma sample. Trypsin, being a protease, can digest itself under the conditions of sample digestion, but is stable if stored at low pH (e.g., in 1 mM HCl) where it is not enzymatically active. After the trypsin has digested the sample proteins, it is important in some situations, such as the SISCAPA protocol, to stop further proteolytic action—this can be achieved for example by addition of a 2-fold excess of a high affinity trypsin inhibitor such as tosyl-L-chloromethylketone (TLCK) (or by other inhibitors such as the soybean trypsin inhibitor (SBTI), difluorophosphate (DFP) or aprotinin).

Hence an effective digestion protocol can be carried out by the following steps:
1) Add 10 μl plasma sample to a vessel containing, in substantially dry form, i) the amount of solid urea contained in 16.9 μl of a 9M urea solution (=˜9 mg urea; this is the volume of a 9M urea solution that includes 10 ul of water); ii) the amount of TrisHCl buffer contained in 16.9 μl of 0.5M TrisHCl at pH 8.5 (=˜1.1 mg TrisHCl taken as the solid yielding pH 8.5; Trizma Preset 8.5 from Sigma Chemical Co.); and iii) the amount of TCEP providing a 2-fold excess over the calculated cysteine content of the sample proteins (=0.15 mg TCEP). Mix and incubate for 30 min at 37 C to effect protein denaturation and disulfide reduction.
2) Add a 2-fold molar excess of IAm over protein cysteine sulfhydryls (=˜0.07 mg IAm) to alkylate the cysteine residues and prevent the reformation of disulfide bonds. Mix and incubate 15 min at 37 C in the dark (IAm is a photosensitive iodine-containing reagent).
3) Add a 2-fold molar excess of DTE over protein cysteine sulfhydryls (i.e., same molar amount as previously added IAm; =0.06 mg DTE). Mix and incubate 1 min at room temperature to eliminate previously unreacted IAm.
4) Add water (˜135 μl minus the volumes associated with the IAm and DTE additions above) to dilute the urea to 1M, thereby allowing trypsin to function. Mix.
5) Add 37 μg of trypsin enzyme in a small volume of 1 mM HCl. This small amount of HCl does not significantly lower the pH of the sample because of the buffer power of the sample itself and the TrisHCl added at the beginning. Mix and incubate 15 hr at 37 C.
6) Add 1.1 μg of tosyl-L-lysylchloromethylketone (TLCK: a 2-fold molar excess over the trypsin added previously) to eliminate trypsin activity in the sample digest, and thus any risk of destroying antibodies added later as part of the SISCAPA process.

A variety of methods are available for placing the dry urea, TCEP and TrisHCl in the vessel to which the plasma sample is added. The simplest method is to prepare a solution of 9M urea, 54 mM TCEP, 0.5M TrisHCl at pH 8.5, dispense 16.94, of this solution into the vessel and lyophilize or otherwise gently dry the liquid (e.g., by placement in a dry incubator at 37 C for several hours) to provide dry reagents in the vessel. The vessel can be sealed (for example using a screw cap or stopper for individual vessels or a microplate sealing film when the vessel is a well in a mutiwell microplate) to prevent introduction of water vapor from the air, stored at room temperature, and the seal removed just prior to use.

It will be clear to one skilled in the art that other denaturants can be used in place of urea (e.g., guanidine HCl, ammonium thiocyante and the like); other disulfide reducing agents can be used in place of TCEP (e.g., DTE, dithiolthreitol); other alkylating agents can be used (e.g., iodoacetic acid, acrylamide, etc.); other sulfhydryl reagents can be used in place of cysteine (dithioerythritol, glutathione, etc.); other enzymes can be used (e.g., lys-C, chymotrypsin, pepsin, papain, etc.); and other antiproteases used to stop the enzyme selected (e.g., aprotinin, TPCK, etc. as appropriate for the enzyme used).

Equivalent kits can be designed for other volumes of similar samples by proportionately adjusting the amounts of the reagents used. Specific amounts of reagents used within the method can also be adjusted according to the actual amounts of protein and cysteine sulfhydryls present in a particular sample type. The amount of protease can be adjusted to achieve faster or slower digestion, or, with a different protease, a different set of resulting peptides. These adjustments can be made based on theoretical calculations (as in the case of the estimation of the cysteine content of normal human plasma) or based on evaluation of experiments.

In some cases, it may be found that steps 3 (Cysteine) and/or 6 (TLCK) may be optional if persistence of some IAm or trypsin (respectively) activity does not impact the analytical results. In some cases, the reagents required for disulfide reduction and alkylation may be dispenses with altogether—e.g., when the peptides to be measured are released efficiently by proteolytic digestion without reduction and alkylation.

Urea-Based Addition-Only, all Reagents Prepared in Dry Form.

In a second embodiment, the method of the first embodiment described above is further simplified by providing all of the reagents used in steps 1-6 in the lyophilized form. As calculated above, the amounts of each reagent needed to process a 10 μl sample of human plasma are estimated as follows:

| Reagent | | Per Sample |
|---|---|---|
| 1 | Urea | 9.133 mg |
| | Tris(2-carboxyethyl)phosphine | 0.154 mg |
| | hydrochloride (TCEP) | |
| | TrisHCl pH 8.5 | 1.110 mg |
| 2 | Iodoacetamide | 0.074 mg |
| 3 | L-cysteine | 0.049 mg |
| 4 | Trypsin | 0.037 mg |
| 5 | Nα-Tosyl-L-lysine chloromethyl | 0.0011 mg |
| | ketone hydrochloride (TLCK) | |

Each of the five reagent reagents, which are combined with the sample in separate steps, are prepared in dry form by first making 5 solutions containing the specified amounts of each in a conveniently lyophilizable volume of appropriate solvent, dispensing this volume of each of the solutions in appropriate vessels, and finally lyophilizing the solutions to produce the correct amount of each reagent in solid form.

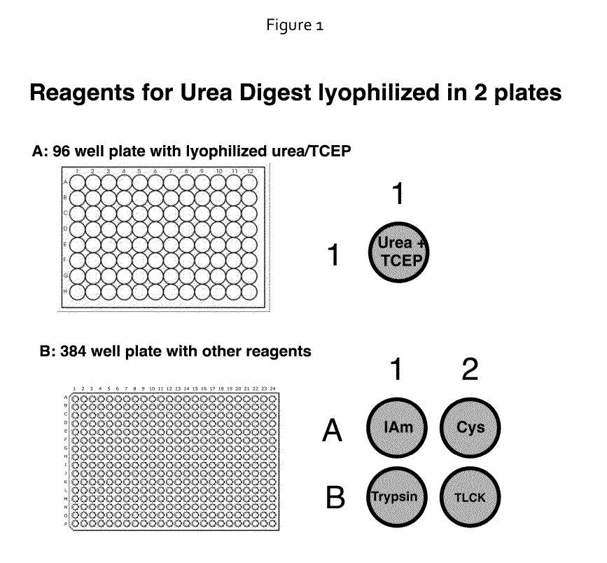

In this embodiment, it is convenient to place the urea/TCEP/Tris reagent mixture in wells of a first plate (Plate 1) having 96-wells of approximately 250 μL capacity each (i.e., a typical 96-well plate design), so that the subsequent reagent addition steps can be carried out in these wells. Reagents 2-5 are placed in the wells of a second plate (Plate 2) having 384 wells, such that each reagent is placed in 96 wells according to a pattern associated with conventional 96 well plate spacing—thus allowing a conventional 96-channel pipette head in a robotic liquid handling system to access all 96 wells of a reagent at once. This approach, in which a 384 well plate is accessed as 4 “interleaved” 96 well arrays, is common in the art of robotic sample handling. Thus, as shown in FIG. 1, reagent 2 is placed in well A1 and 95 other wells in the standard 96-well pattern within the 384 well plate B; reagent 3 in well A2 and 95 other wells in the standard 96-well pattern; reagent 4 in well B1 and 95 other wells in the standard 96-well pattern; and reagent 5 in well B2 and 95 other wells in the standard 96-well pattern.

The digestion process can be carried out efficiently by either robotic or manual means (manual processing typically requiring a multichannel pipette). After the samples have been added to the wells of Plate 1 and incubated, each successive reagent addition is carried out by adding a small volume (e.g., 10 μL) of water to each of the respective 96 wells in Plate 2 containing the appropriate reagent (i.e., beginning with reagent 2, which in this case is IAm), dissolving the dried reagent in this liquid either passively or by pipetting the liquid in and out repeatedly, and finally transferring substantially all the added liquid to the respective wells of Plate 1, thereby adding to each sample well in Plate 1 a measured, generally identical, amount of the reagent. After the appropriate incubation, the next reagent is similarly dissolved and transferred to Plate 1, and so on until all the successive reagent addition steps have been accomplished. While it is possible to transfer the sample to each successive reagent well instead, the described process of transferring reagents 2-5 into the original sample well is preferred since this avoids any potential for loss of sample components due to incomplete transfer of the fluid volume and hence avoids any diminution of the measured analyte in the initial sample aliquot due to fluid handling losses. In addition, the contents of typical 96-well plate wells can be effectively mixed by orbital shaking, whereas fluids in smaller wells (e.g., 384 well plate wells) are difficult to mix effectively.

Urea Addition-Only, all Reagents Prepared as Dissolvable Tablets.

In a third embodiment, the reagent aliquots are lyophilized in bulk as dissolvable tablets and subsequently placed in suitable vessels. This can be accomplished using, for example, a technology like that described as “LyoSphere” technology (BIOLYPH LLC, Hopkins, Minn.): “A LyoSphere is a microliter aliquot of liquid that has been lyophilized as a precise and durable sphere to be packaged inside virtually any device awaiting rehydration. LyoSpheres are shelf-stable, consistent, robust, and instantly rehydrated.”

In one version of this embodiment, 5 different types of dissolvable tablets are manufactured, each containing the constituents listed below as reagents 1-5. One or more excipients that are inert with respect to the digestion process, and ideally that do not interfere in subsequent mass spectrometric analyte detection, may be added to the reagent compositions in order to assist in uniform lyophilization behavior. A wide variety of such exipients exist, including sugars, such as sucrose, dextrose and trehalose. The tablets manufactured in this way dissolve rapidly in aqueous solvents, allowing the reagents to be dissolved, by addition of water, for example, and then pipetted within 15-60 seconds.

The reagent tablets used in the method can be created by a variety of means some of which are highly developed in the pharmaceutical industry. For example, the tablets can be made by compaction of powdered reagents in a tablet-making machine as is used to make drug tablets. In this case, as is typical with drugs, a series of excipients and other additives will be tested to achieve good tablet strength, proper release of tablets from the tablet molds, and effective dissolution of the tablets upon addition of liquid sample. All of these properties, and the means for optimizing tablet performance with respect to them, are well known to those skilled in the art, as are the reagents, techniques, machines and optimization procedures needed to product reagent tablets for use in the methods described herein. Alternatively the tablets can be made by drying aliquots of the reagents prepared in liquid form, either in air, under a gas stream or in vacuum (i.e., lyophilization, e.g., as denaturant tablet or LyoSpheres). When the ‘tablets’ are prepared in the vessel in which they will be used, and are thus not required to be handled individually, the form of the tablet is of little importance and need not be regular in shape—it can in fact be a solid plate or mass of crystals on the wall of the vessel.

In a variation of this embodiment, the three components of reagent 1 (urea, TCEP and TrisHCl) can be prepared as three different tablets each containing the appropriate amount of one of the three substances. Thus one of each of these three types of tablets is placed in each well of Plate 1. Upon dissolution due to sample addition, all three tablets dissolve and contribute their reagent to the process.

| | | Per Denaturant |
|---|---|---|
| Reagent | | tablet or LyoSphere |
| 1 | Urea | 9.133 mg |
| | Tris (2-carboxyethyl)phosphine | 0.154 mg |
| | hydrochloride (TCEP) | |
| | TrisHCl pH 8.5 | 1.110 mg |
| 2 | Iodoacetamide | 0.074 mg |
| 3 | L-cysteine | 0.049 mg |
| 4 | Trypsin | 0.037 mg |
| 5 | Nα-Tosyl-L-lysine chloromethyl | 0.0011 mg |
| | ketone hydrochloride (TLCK) | |

As described above, the reagents are placed in appropriate wells of multiwell plates and then the wells are sealed to prevent entry of water (as humidity in the air) until use. The layout of FIG. 1 provides an example of placement of the reagent dissolvable tablets in the wells of two multiwell plates.

The different types of dissolvable tablets can optionally contain differently colored dyes to assist in confirming (either visually or by means of machine vision) that the correct tablets are in the appropriate wells of each plate, at the time of manufacturing, and later, at the time of use.

Digestion and SISCAPA Reagents (Ab, SIS).

In a fourth embodiment, a kit combines sample digestion and subsequent SISCAPA enrichment of signature peptides to provide a complete process for quantitation of protein biomarkers in a biological sample. While, in many published SISCAPA protocols, a sample digest is “cleaned up” using a solid phase extraction (SPE) procedure to separate the tryptic peptides from the other components of the original sample (e.g., lipids, salts, metabolites, etc.) prior to exposure of the peptides to SISCAPA antibodies, it has recently been observed that this SPE step is not generally necessary: the SISCAPA antipeptide antibodies are, in many cases, capable of binding and retaining their respective signature peptide targets in the presence of such salt, metabolites, etc that are present for example in human plasma. The elimination of the SPE step is highly desirable in a SISCAPA workflow because of the time and expense involved in SPE procedures (e.g., using Merck Millipore Oasis HLB material in cartridges or plates), and the largely unknown potential for selective loss of some peptide components. While in general it is wise to avoid exposing antibodies to strong denaturants, it has been observed that many SISCAPA antibodies are capable of binding signature peptides in the presence of 1M urea—the concentration present during trypsin digestion in the protocol described here—or even higher concentrations (e.g., 2M urea). Thus the SISCAPA method should be applicable directly to samples generated by the urea-based addition-only sample digestion method described above (i.e., no post-digestion SPE, with peptides delivered in 1M urea). This strategy would make it advantageous to deliver digestion and SISCAPA kits in a similar format and potentially combine them in the same kit.

The two specific reagents required in a SISCAPA assay (a stable isotope labeled peptide internal standard (SIS) and an antipeptide antibody (APA)) can also be provided on an individual assay basis pre-measured in dry form or incorporated into dissolvable tablets. In typical SISCAPA configurations, 100 fmol of SIS and 1 μg of APA is added to each sample in carrying out the SISCAPA assay. In one preferred approach, the SIS and APA are provided in separate vessels such that the SIS can be dissolved and added to the digested sample first (thereby achieving the pre-analytical combination and mutual dilution of analyte and internal standard that is the basis of a successful stable isotope dilution method), after which the APA is dissolved and added. The APA may comprise antibody protein alone, or antibody coupled to magnetic beads.

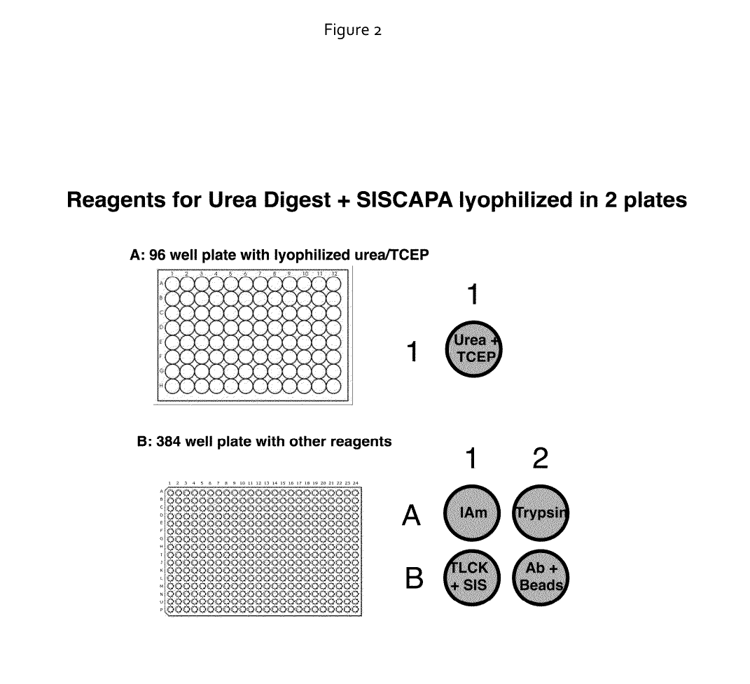

Alternatively the SIS and APA can be prepared in dissolvable tablets that differ in dissolution speed, such that the SIS tablet dissolves before the APA tablet, and both tablets (i.e., one of each type of tablet) placed in a single vessel or well to which the digest is added. In this format, two reagent addition steps are carried out automatically in succession upon combination of the digest with the two tablets: the digest first dissolves the SIS tablet, causing mixing of the signature peptide analyte and the SIS internal standard (the ratio of their abundances after complete mixing is the intended readout of the assay), and then the APA tablet dissolves, initiating the capture of the SIS and signature peptides and their subsequent separation from unbound peptides for the SISCAPA process. If the APA antibodies bound an appreciable amount of SIS peptide before mixing with the digest, this ratio would be skewed and the assay result biased. A variety of means exist to selectively alter the dissolution speed of the SIS and APA tablets, including choice of excipients present during lyophilization, coatings applied to the tablets and other methods known in the art to control dissolution of drugs, fertilizers, etc. An example of a kit layout in two plates is shown in FIG. 2. Here the first plate contains the urea denaturant and TCEP reducing agent as in the first embodiment. The four 96 well subarrays of a 384 well plate used subsequently contain IAm alkylating agent and trypsin in subarrays startiant at wells A1 and A2 respectively (the cysteine reagent being delted in this protocol), while TLCK (trypsin inhibitor) is combined with SIS peptide in the third subarray starting at B1 and a combination of APA and magnetic beads provided in the subarray beginning at B2. In this format all the reagents for digestion and the SISCAPA method can be incorporated into two plates as dried reagents.

SISCAPA Kit.

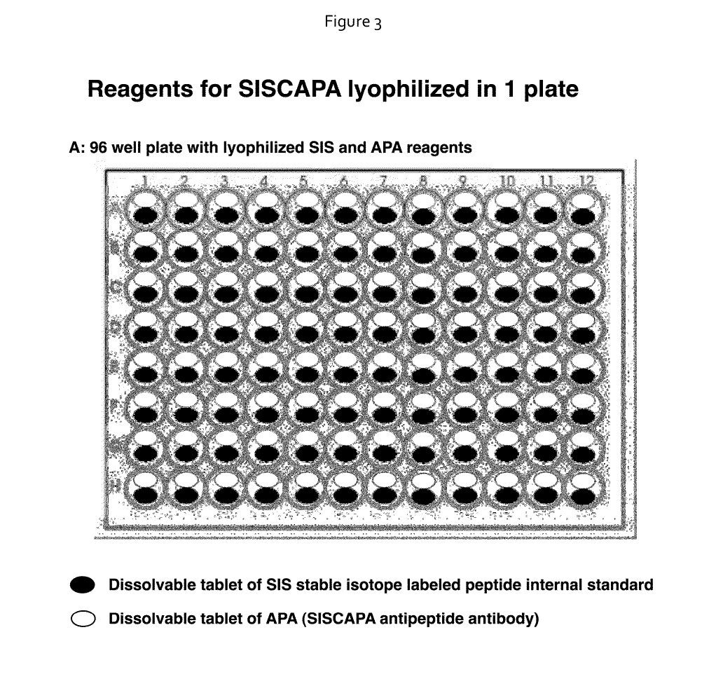

In a fifth embodiment, the SIS and APA tablets described above, formulated so that SIS dissolves before APA, are packaged together, without digestion reagents, in a vessel, or array of similar vessels such as a 96 well plate, thus simplifying delivery of the components of a SISCAPA assay, as shown in FIG. 3. In this format, two reagent addition steps are carried out automatically in succession upon combination of the digest with the two tablets: the digest first dissolves the SIS tablet, causing mixing of the signature peptide analyte and the SIS internal standard (the ratio of their abundances after complete mixing is the intended readout of the assay), and then the APA tablet dissolves, initiating the capture of the SIS and signature peptides and their subsequent separation from unbound peptides for the SISCAPA process.

Dissolvable Tablets Contain Magnetic Particles Enabling their Manipulation.

In a sixth embodiment, the dissolvable tablets of the third or fifth embodiments contain, in addition to the required reagents, a small quantity of paramagnetic particles. These particles, added to the reagent prior to lyophilization, are incorporated into the tablets and thereby allow the tablets to be attracted to an external magnet. This allows the use of an alternative means of adding the reagent(s) contained in a tablet to a sample: the tablet can be picked up from a storage container (e.g., a microplate well) by a magnetic probe, and transported to a sample well where the tablet can be lowered into contact with the sample liquid, which liquid dissolves the tablet thereby adding its reagents to the sample. The magnetic particles, which in this case are designed so as to be inert with respect to the reagents and processes occurring during sample processing, may remain in the sample, or be removed by a magnetic probe.

The probe(s) used to transport the tablet(s) can be designed so as to provide a reversible attractive force to the beads: in the ThermoFisher Kingfisher device, an array of movable permanent magnets slide inside plastic closed-end sleeves so that the magnets, when placed fully into the sleeves and contacting their closed ends, can attract paramagnetic bodies (such as the “magnetic” tablets incorporating paramagnetic beads as described here) to ‘stick’ to the outside of the sleeves and allow their transport. After arrival at the desired position, in this case in or over the sample vessel, the magnets can be withdrawn from the end of the sleeves, thereby moving away from the tablets—this diminishes the magnetic attraction felt by the tablets and causes them to drop off the sleeves and into the samples where they dissolve.

Alternatively, the tablets can be attracted to, and transported by an array of permanent magnetic probes whose magnetic force is sufficient to lift them from the vessels in which they are delivered: once in position over the sample wells, an array of stronger magnets is placed beneath the sample plate so as to attract the tablets away from the probes and downward into the sample liquid. These and other equivalent means familiar to those skilled in the art will allow the transport of dissolvable tablets containing paramagnetic or ferromagnetic particles or materials from storage containers to sample containers where they dissolve to provide reagents in the described protocols.

The foregoing disclosure outlines a number of embodiments in terms of the SISCAPA method and associated quantitative mass spectrometry methods, and therefore represents one set of embodiments that may be employed in the application of the present technology. It will be appreciated that the methods and compositions disclosed herein are not limited to the SISCAPA method, but may be applied to other methods that employ internal peptide standards and the like.

### Example

The addition-only tryptic digestion method was implemented using an Agilent high-precision liquid handling robot and applied to replicate aliquots of a pooled human plasma sample obtained from Bioreclamation, Inc. Each digested sample consisted of 10 ul of this pooled plasma. The digestion protocol was carried out as follows, making use of the Bravo robot (Agilent Technologies):

| Bravo Accessories | Bravo Accessories Recommended for Future |
|---|---|
| Required for this SOP | and Fully Automated Versions of this SOP |
| Orbital shaking station | Pump module 2.0 |
| Custom Magnet Array | 96 AM wash station |
| Plate (see notes in appendix | Inheco STC controller × 2 |
| I) | Peltier thermal station and plate nest × 2 |
| | Risers |
| | Gripper upgrade |

| Bravo Consumables | |
|---|---|
| Required | Notes |
| 96 LT 200 μl tips | Agilent Item #: 06880-102 |
| 8-well Reagent Plate | Axygen Cat. #: RES-MW8-LP 8 row reagent |
| | reservoir (4 ml) |
| 96-well PCR Plate | Bio-Rad Cat. #: HSP-9611 96 well PCR plate |
| 96-well Black Plate | Greiner Cat. #: 651209 |
| | 96 well, V-bottom, black plate |
| Bio-Rad Microseal Film | Bio-Rad Cat. #MSF 1001 |

| Reagents Required | Notes |
|---|---|
| Plasma or serum to | |
| be digested | |
| Stable Isotope Standard | Provided by SISCAPA Assay Technologies |
| (SIS) peptide | |
| Urea | Ultra Urea; Sigma-Aldrich |
| TCEP (tris(2- | Bondbreaker neutral TCEP solution; |
| carboxyethyl)phosphine) | Thermo Scientific |
| Tris 8.1 | Trizma preset crystals pH 8.1; Sigma-Aldrich |
| Trypsin | TRTPCK; Worthington Biochemical |
| Iodoacetamide | Sigma-Aldrich |
| TLCK (tosyl-L-lysyl | Fluka Biochemica |
| chloromethyl ketone) | |
| Protein G coated | Life Technologies Dynal 2.8 uM Protein |
| magnetic beads | Beads G Magnetic |
| SISCAPA anti-peptide | High-affinity rabbit monoclonal |
| antibody | anti-peptide antibodies [symbol] ovided by |
| | SISCAPA Assay Technologies |

[symbol]

indicates data missing or illegible when filed

| | Volume required per 10 μl | |
|---|---|---|
| Solutions to Prepare | plasma/serum sample | |
| Stage 1: Digest Plate Preparation | | |
| Urea Mixture: 9M Urea + 0.05M TCEP + 0.5 M Tris pH 8.1 | 17 | μl |
| in H₂O | | |
| Stage 2: Trypsin Digestion | | |
| Iodoacetamide solution: 40.2 mM (7.5 mg/ml) iodoacetamide | 10 | μl |
| in H₂O (to achieve 3 fold excess over plasma cysteines) | | |
| Tris buffer solution: 0.25 M (35 mg/ml) Tris pH 8.1 in H₂O | 115 | μl |
| Trypsin solution: 0.15 mM (3.7 mg/ml) Trypsin in 10 mM HCl | 10 | μl |
| (to achieve a final protein/trypsin ratio of 20:1) | | |
| Stage 3: Stopping the Digestion, SIS Addition, Enrichment | | |
| TLCK solution: 0.3 mM (0.11 mg/ml) TLCK in 10 mM HCl | 10 | μl |
| (to achieve 2x excess over trypsin) | | |
| SIS peptide solution: SIS peptide(s) in PBS + 0.03% CHAPS | 10 | μl |
| (SIS concentration varies depending on assay) | | |
| Antibody-beads solution: 0.1 μg/μl antibody coupled to | 10 | μl |
| sufficient amount of washed magnetic beads (usually 5 μl of 30 mg/ml | | |
| magnetic beads per 1 μg of antibody) in 1x PBS + 0.03% | | |
| CHAPS pH 7.4 | | |
| Stage 4: Preparing wash and elution stocks | | |
| Wash Buffer: 1x PBS + 0.03% CHAPS pH 7.4 | 3 × 150 | μl |
| Elution Buffer: 0.1% Formic acid | 25 | μl |
| Stage 5: Wash and elution | | |
| Use plate prepared during stage 4 | | |

Bravo Method Files Required

| | |
|---|---|
| Stage 1: Digest Plate Preparation | “20130116 SISCAPA - Stage 1.pro” |
| | “20130116 SISCAPA - Stage 1.vzp” |
| Stage 2: Trypsin Digestion | “20130116 SISCAPA - Stage 2.pro” |
| | “20130116 SISCAPA - Stage 2.vzp” |
| Stage 3: Stopping the Digestion, | “20130116 SISCAPA - Stage 3.pro” |
| SIS Addition, Enrichment | “20130116 SISCAPA - Stage 3.vzp” |
| Stage 4: Preparing wash and | “20130116 SISCAPA - Stage 4.pro” |
| elution stocks | “20130116 SISCAPA - Stage 4.vzp” |
| Stage 5: Wash and elution | “20130116 SISCAPA - Stage 5.pro” |
| | “20130116 SISCAPA - Stage 5.vzp” |

### Method

### Stage 1: Digest Plate Preparation

1. Enter calibration data into VWorks (Tools→Labware Editor) for the following plates using dimensions in “Bravo Consumables Required” table above:
   a. 96 LT 200 μl tips
   b. 8-well Reagent Plate
   c. 96-well PCR Plate
   d. 96-well Black Plate
2. Generate a 2 μL/sec and a 10 μL/sec liquid class (Tools→Liquid Library Editor) using the parameters in the Liquid Library table above.
3. For each protocol make sure to select the appropriate ‘device file’ under protocol options.
4. With the “Simulation” mode turned on, run the protocols to ensure their integrity.
5. Prepare Digest Plates:
   a. Fill each of the 8 wells of the Urea Reagent Plate with 4 ml of the 9 M Urea+0.05 M TCEP+0.2 M Tris pH 8.1 in H₂O mixture (if you require fewer than 6 digest plates you will need to adjust the method accordingly).
   b. Place labware in appropriate positions according to the Bravo Deck Layout below:
   c. Run the “20130116 SISCAPA—Stage 1.pro” protocol. This protocol populates all wells of 6 Sample Plates with the urea mixture. The robot dispenses 17 μL per well, the amount required for digesting 10 μL of human plasma.
   d. When the method is complete put the uncovered Digest Plates in a dry 37° C. incubator overnight.
   e. In the morning check that the liquid has evaporated completely.
6. Cover Digest Plates with a plate seal and store in dry and dark conditions until ready for use.
   Stage 2: Trypsin Digestion
1. Load method file named “20130116 SISCAPA—Stage 2.pro” into VWorks.
2. Add a minimum of 12 μl of plasma/serum to the wells of a 96-well Sample Plate; 10 of this plasma will be transferred to the dried urea mixture plate by the robot.
3. Cover the edges of the IAm/Tris/Trypsin Reagent Plate with black tape in order to minimize exposure of the iodoacetamide to UV light.
4. Load 4 mL of Iodoacetamide solution in row A of the IAm/Tris/Trypsin Reagent Plate.
5. Load 8 mL of the Tris buffer solution in rows B and C of the IAm/Tris/Trypsin Reagent Plate.
6. Load 4 mL of Trypsin solution in row D of the IAm/Tris/Trypsin Reagent Plate.
7. Place a microseal film on top of the IAm/Tris/Trypsin Reagent Plate.
8. Place labware in appropriate positions according to the Bravo Deck Layout figure above.
9. Run the “20130116 SISCAPA—Stage 2” method.
   a. During the first 30 min of the method 10 ul of each plasma sample is added to the dried urea mixture plate, mixed and incubated.
   b. At t=˜32 min you will be prompted to remove the microseal from the IAm/Tris/Trypsin Reagent Plate. At this point 10 μl of iodoacetamide is added to each well of the Digest Plate.
   c. You will be prompted to place the microseal on the Digest Plate ˜35 mins into the program.
   d. You will be prompted to remove the microseal from the Digest Plate ˜70 mins into the program. At this point 115 μl of the Tris and 10 μl of the trypsin solution are added to the 96-well sample plate containing plasma samples.
   e. In each case press “Continue” after you have transferred the Microseal (note: a future version of this method will employ an Agilent Benchbot in order to automate the plate lid removal process).
10. After the completion of the program, place a microseal on the 96-well Digest Plate containing the plasma digestion reactions and transfer to a humidified 37° C. incubator for 6 hours (note this time may vary depending on optimization of yield for the particular analyte peptide(s) being measured).
   Stage 3: Stopping the Digestion, SIS Addition, Enrichment
1. Load method file named “20130116 SISCAPA—Stage 3.pro” into VWorks.
2. Place labware in appropriate positions according to the Bravo Deck Layout figure above.
3. Load 100 μL/well of TLCK solution in the first row of the TLCK and Ab/Beads Reagent Plate.
4. Load 100 μL/well of 0.1 μg/μL antibody coupled to protein G magnetic beads to the second row of the TLCK and Ab/Beads Reagent Plate.
   a. To make the Ab-Bead Complex: Wash the required amount of beads (according to manufacturer's instructions) 3 times in PBS/0.03% CHAPS. Incubate the required amount of antibody (diluted in PBS/0.03% CHAPS if necessary) with the beads for 1 hour at room temperature with rigorous mixing.
5. Load 20 μl/well of SIS peptide to the SIS Reagent Plate. 10 μl of this solution will be added to each digested plasma sample. Note that for greatest reproducibility it is important to store SIS peptide solution in a 96-well format, as opposed to one common stock in an 8-well reagent plate.
6. Run the “20130116 SISCAPA—Stage 3” method.
   a. TLCK (10 μl per well) will be added to each plasma/serum sample to stop trypsin digestion.
   b. SIS peptide (10 μl per well) will be added to each digested plasma/serum sample.
   c. Antibody-coupled magnetic beads (10 μL per well) will be added to each digested plasma/serum sample and the mixture is incubated with shaking for 1 hour to enrich endogenous analytes.

After sample digestion carried out as described above, a multiplex of 4 SISCAPA assays were carried out using the Bravo robot as described in Agilent Application Note 5990-7360EN (“Automation of a SISCAPA Magnetic Bead Workflow for Protein Biomarker Quantitation by Mass Spectrometry Using the Agilent Bravo Automated Liquid Handling Platform”) Published in the U.S.A., Jan. 25, 2011.

The four SISCAPA assays used measure 1) soluble mesothelin (peptide LLGPHVEGLK), 2) protein C inhibitor (peptide EDQYHYLLDR), 3) soluble transferrin receptor (peptide GFVEPDHYVVVGAQR), and 4) LPS-binding protein (peptide LAEGFPLPLLK). In each case a high-affinity rabbit monoclonal antibody was used for target peptide enrichment (typically at a level of lug antibody per SISCAPA capture reaction), and a synthetic version of each target peptide having a U-¹⁵N, U-¹³C-labeled c-terminal arginine or lysine was used as the internals standard (SIS), typically added at a level of 100 to 500 fmo per sample.

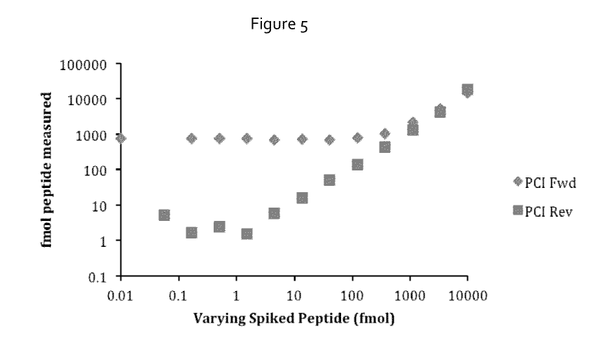

As shown in FIG. 5 for the PCI assay, the assay has a linear dynamic range of approximately 10,000-fold (the PCI Rev curve showing a dilution of the labeled peptide, which has no endogenous interference), and measures a stable endogenous value for PCI in the standard addition curve (the PCI Fwd curve showing a dilution of the unlabeled peptide, which shows the endogenous analyte level).

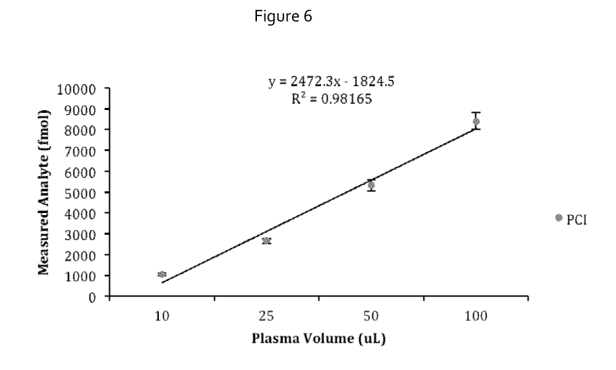

FIG. 6 shows that the measured amount of PCI peptide scales linearly with the amount of plasma digested using the methods described herein, demonstrating equal effectiveness of the method at various scales over a factor of at least 10.

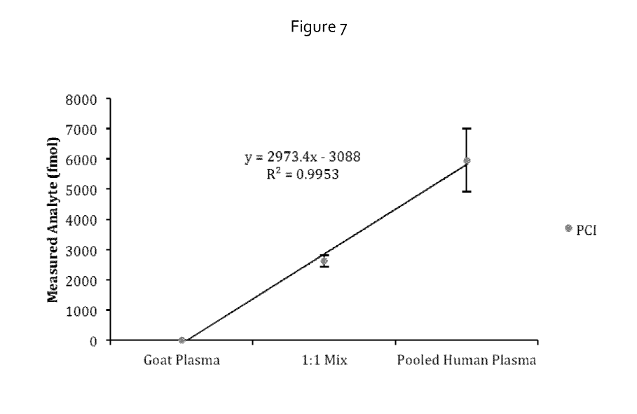

FIG. 7 shows the linearity of response when human plasma is diluted in or replaced by goat plasma (which, based on the goat genomic sequence, contains no tryptic peptide identical to the PCI peptide used here).

These results show that the digestion methods described herein produce reliable analytical results over a range of scales. In this example the digestoin was followed by the SISCAPA method for peptide enrichment, and the results demonstrate that the SISCAPA antibody capture is efficient and reliable when carried out in 1M urea remaining in the digest. This is a surprising result, and one which substantially simplifies the workflow by eliminating the need to remove the urea denaturant prior to antibody capture.

In this experiment, the following CV values were obtained for four separate SISCAPA assays. Each value was calculated as the standard deviation divided by mean value of the measured ratio of target peptide peak area divided by the peak area of the corresponding labeled internal standard peptide (spiked at 500 fmol per sample) for 12 complete process replicates using aliquots of the same pooled human plasma sample. The first line (Digest+SISCAPA+MS) shows the total workflow CV. The second row (SISCAPA+MS) shows the combined CV of the SISCAPA capture and MS steps, achieved by pooling 12 digests (to achieve homogenity) and then splitting this pool into 12 samples prior to SISCAPA and MS. The third row shows the CV's resulting from pooling 12 samples after digestiong and SISCAPA, and then splitting this pool into 12 aliquots prior to MS analysis. Hence the bottom row shows the CV of MS detection itself, the second row shows the CV of MS and SISCAPA on top of it, while the top row shows the CV of all three process steps. It is clear that the CV of the whole workflow is only very slightly greater than the CV of the underlying MS measurement, indicating that the contribution of the digestion to overall CV is very small. Monte Carlo statistical modeling indicates that the CV of the digestion step alone (if it could be measured independent of the MS CV) ranges from 0-2.0% CV. This extremely high precision in a proteolytic process is unexpected and unprecedented in protein analysis.

| | Meso_light | PCI_light | TfR_light | LPSBP_light |
|---|---|---|---|---|
| | Results | Results | Results | Results |
| Digest + | 4.2% | 2.8% | 3.0% | 2.9% |
| SISCAPA + | | | | |
| MS | | | | |
| SISCAPA + MS | 4.4% | 2.5% | 2.0% | 3.2% |
| MS | 5.4% | 2.3% | 2.1% | 2.1% |

1. A kit for proteolytic digestion of a liquid sample containing proteins, said kit comprising a vessel in which a measured quantity of a protein denaturant is provided in substantially dry form, said quantity being sufficient, when dissolved by addition of said fluid sample, to promote the denaturation of said proteins.

2. The kit of claim 1 wherein the protein denaturant is chosen from among urea, guanidine hydrochloride, ammonium thiocyanate, deoxycholate, sodium dodecyl sulfate, and “Rapigest”.

3. The kit of claim 1 wherein a pH buffering substance is also included in said vessel in dry form.

4. The kit of claim 1 wherein a disulfide reducing substance is also included in said vessel in dry form.

5. The kit of claim 1, 2 or 3 in which said substance(s) are provided as denaturant tablets or LyoSpheres.

6. A kit for proteolytic digestion of a liquid sample containing proteins, said kit comprising a plurality of vessels in which measured quantities of reagents are provided in substantially dry form, said vessels including at least two of:
a vessel containing a quantity of a protein denaturant, said quantity being sufficient, when dissolved by addition of said fluid sample, to promote the denaturation of said proteins; a pH buffering substance; and a disulfide reducing substance;
a vessel containing a quantity of a sulfhydral reactive substance;
a vessel containing a quantity of a sulfhydral-containing substance;
a vessel containing a quantity of a proteolytic enzyme;
a vessel containing a quantity of a an inhibitor of the activity of said proteolytic enzyme.

7. The kit of claim 6 in which said reagents(s) are provided as denaturant tablets or LyoSpheres.

8. The kit of claim 6 in which at least one of said dry reagents is provided in the form of a dissolvable tablet inserted into a vessel after its formation.

9. The kit of claim 7 in which said tablet also contains one or more paramagnetic particles.

10. A reagent kit for the SISCAPA method comprising
a sealed vessel having an opening, said opening sealed by a removable covering,
a first dissolvable tablet containing a stable isotope labeled peptide,
a second dissolvable tablet containing a binding agent capable of specifically binding said peptide
wherein said first and second tablets are provided contained in said vessel, and
wherein said first tablet substantially dissolves in a liquid sample before said second tablet dissolves.

11. A reagent kit containing reagents in dried form and a method for its use, wherein
at least one of said reagents is provided in the form of a dissolvable tablet,
said tablet contains magnetically responsive particles
magnetic force is used to move said tablet into a volume of liquid in which it dissolves.

12. A method for proteolytic digestion of protein containing samples consisting of a series of additions of liquids to a vessel containing dry reagents, wherein
a measured quantity of a protein denaturant is provided within a vessel in substantially dry form,
a quantity of a liquid sample sufficient to dissolve said denaturant is transferred into said vessel,
after denaturation, a volume of diluent is added to said vessel to reduce the denaturant concentration to a level compatible with the proteolytic activity of trypsin,
trypsin is added to digest the sample proteins.

13. The method of claim 12 wherein the denaturant is urea and the concentration of urea after dissolution in the sample is greater than 8M.

14. The method of claim 12 followed by SISCAPA enrichment of a target peptide and measurement of peptides by mass spectrometry.
